(19) United States
(12) Patent Application Publication
(10) Pub. No.: US 2009/0080737 A1
(43) Pub. Date: Mar. 26, 2009

(54) System and Method for Use of Fluoroscope and Computed Tomography Registration for Sinuplasty Navigation

(75) Inventors: Vianney P. Battle, Salt Lake City, UT (US); Richard A. Leparmentier, Salt Lake City, UT (US); Cristian Atria, Wakefield, MA (US); Raguraman Sampathkumar, Somerville, MA (US); Laurent Jacques Node-Langlois, Boston, MA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/860,644

(22) Filed: Sep. 25, 2007

(51) Int. Cl. G06K 9/62

(52) U.S. Cl. 382/131

(57) ABSTRACT

Certain embodiments of the present invention provide systems and methods of improved medical device navigation. Certain embodiments include acquiring a first image of a patient anatomy, a second image of patient anatomy, and creating a registered image based on the first and second images. Certain preferred embodiments teach systems and methods of automated image registration without the use of fiducial markers, headsets, or manual registration. Thus the embodiments teach a simplified method of image registration that allows a medical device to be navigated within a patient anatomy. Furthermore, the embodiments teach navigating a medical device in a patient anatomy with reduced exposure to ionizing radiation. Additionally, the improved systems and methods of image registration provide for improved accuracy of the registered images.

### BACKGROUND OF THE INVENTION

The present invention generally relates to improved systems and methods for medical device navigation. More particularly, the present invention relates to improved image registration and navigation of a surgical device in a patient anatomy.

Medical practitioners, such as doctors, surgeons, and other medical professionals, often rely upon technology when performing a medical procedure, such as image-guided surgery or examination. A tracking system may provide positioning information for the medical instrument with respect to the patient or a reference coordinate system, for example. A medical practitioner may refer to the tracking system to ascertain the position of the medical instrument when the instrument is not within the practitioner's line of sight. A tracking system may also aid in pre-surgical planning.

The tracking or navigation system allows the medical practitioner to visualize the patient's anatomy and track the position and orientation of the instrument. The medical practitioner may use the tracking system to determine when the instrument is positioned in a desired location. The medical practitioner may locate and operate on a desired or injured area while avoiding other structures. Increased precision in locating medical instruments within a patient may provide for a less invasive medical procedure by facilitating improved control over smaller instruments having less impact on the patient. Improved control and precision with smaller, more refined instruments may also reduce risks associated with more invasive procedures such as open surgery.

Thus, medical navigation systems track the precise location of surgical instruments in relation to multidimensional images of a patient's anatomy. Additionally, medical navigation systems use visualization tools to provide the surgeon with co-registered views of these surgical instruments with the patient's anatomy. This functionality is typically provided by including components of the medical navigation system on a wheeled cart (or carts) that can be moved throughout the operating room.

Tracking systems may be ultrasound, inertial position, optical or electromagnetic tracking systems, for example. Optical tracking systems may employ the use of LEDs, microscopes and cameras to track the movement of an object in a 2D or 3D patient space. Electromagnetic tracking systems may employ coils as receivers and transmitters. Electromagnetic tracking systems may be configured in sets of three transmitter coils and three receiver coils, such as an industry-standard coil architecture (ISCA) configuration. Electromagnetic tracking systems may also be configured with a single transmitter coil used with an array of receiver coils or an array of transmitter coils with a single receiver coil, for example. Magnetic fields generated by the transmitter coil(s) may be detected by the receiver coil(s). For obtained parameter measurements, position and orientation information may be determined for the transmitter and/or receiver coil(s).

In medical and surgical imaging, such as intraoperative or preoperative imaging, images are formed of a region of a patient's body at different times before, during or after the surgical procedure. The images are used to aid in an ongoing procedure with a surgical tool or instrument applied to the patient and tracked in relation to a reference coordinate system formed from the images. Image-guided surgery is of a special utility in surgical procedures such as brain surgery and arthroscopic procedures on the knee, wrist, shoulder or spine, as well as certain types of angiography, cardiac procedures, interventional radiology, cranial procedures on the ear, nose, throat, or sinus and biopsies in which x-ray images may be taken to display, correct the position of, or otherwise navigate a tool or instrument involved in the procedure.

Several areas of surgery involve very precise planning and control for placement of an elongated probe or other article in tissue or bone that is internal or difficult to view directly. In particular, for brain surgery, stereotactic frames that define an entry point, probe angle and probe depth are used to access a site in the brain, generally in conjunction with previously compiled three-dimensional diagnostic images, such as MRI, PET or CT scan images, which provide accurate tissue images. For placement of pedicle screws in the spine, where visual and fluoroscopic imaging directions may not capture an axial view to center a profile of an insertion path in bone, such systems have also been useful.

When used with existing CT, PET or MRI image sets, previously recorded diagnostic image sets define a three dimensional rectilinear coordinate system, either by virtue of their precision scan formation or by the spatial mathematics of their reconstruction algorithms. However, it may be desirable to correlate the available intraoperative fluoroscopic views and anatomical features visible from the surface or in fluoroscopic images with features in the 3-D diagnostic images and with external coordinates of tools being employed. Correlation is often done by providing implanted fiducials and/or adding externally visible or trackable markers that may be imaged. Registration may also by done by providing an external headset in contact with a patient's head. Using a keyboard, mouse or other pointer, fiducials or a headset may be identified in the various images. Thus, common sets of coordinate registration points may be identified in the different images. The common sets of coordinate registration points may also be trackable in an automated way by an external coordinate measurement device, such as a suitably programmed off-the-shelf optical tracking assembly. Instead of imagable fiducials, which may for example be imaged in both fluoroscopic and MRI or CT images, such systems may also operate to a large extent with simple optical tracking of the surgical tool and may employ an initialization protocol wherein a surgeon touches or points at a number of bony prominences or other recognizable anatomic features in order to define external coordinates in relation to a patient anatomy and to initiate software tracking of the anatomic features.

However, there are some disadvantages with previous registration or correlation techniques. Identifying fiducials, markers, or a headset using a keyboard or mouse may be time consuming. It may be desirable to reduce the amount of time required to perform a medical procedure. In addition, the registration of external markers or a headset may not be as accurate as desired. Many surgical procedures are performed within a patient anatomy. Image registration techniques that correlate points external to a patient anatomy may result in a resulting 3-D dataset most accurate at points outside of a patient anatomy. Thus, it may be desirable to correlate points within a patient anatomy.

Generally, image-guided surgery systems operate with an image display which is positioned in a surgeon's field of view and which displays a few panels such as a selected MRI image and several x-ray or fluoroscopic views taken from different angles. Three-dimensional diagnostic images typically have a spatial resolution that is both rectilinear and accurate to within a very small tolerance, such as to within one millimeter or less. By contrast, fluoroscopic views may be distorted. The fluoroscopic views are shadowgraphic in that they represent the density of all tissue through which the conical x-ray beam has passed. In tool navigation systems, the display visible to the surgeon may show an image of a surgical tool, biopsy instrument, pedicle screw, probe or other device projected onto a fluoroscopic image, so that the surgeon may visualize the orientation of the surgical instrument in relation to the imaged patient anatomy. An appropriate reconstructed CT or MRI image, which may correspond to the tracked coordinates of the probe tip, may also be displayed.

Among the systems which have been proposed for implementing such displays, many rely on closely tracking the position and orientation of the surgical instrument in external coordinates. The various sets of coordinates may be defined by robotic mechanical links and encoders, or more usually, are defined by a fixed patient support, two or more receivers such as video cameras which may be fixed to the support, and a plurality of signaling elements attached to a guide or frame on the surgical instrument that enable the position and orientation of the tool with respect to the patient support and camera frame to be automatically determined by triangulation, so that various transformations between respective coordinates may be computed. Three-dimensional tracking systems employing two video cameras and a plurality of emitters or other position signaling elements have long been commercially available and are readily adapted to such operating room systems. Similar systems may also determine external position coordinates using commercially available acoustic ranging systems in which three or more acoustic emitters are actuated and their sounds detected at plural receivers to determine their relative distances from the detecting assemblies, and thus define by simple triangulation the position and orientation of the frames or supports on which the emitters are mounted. Additionally, electromagnetic tracking systems as described above may also be used. When tracked fiducials appear in the diagnostic images, it is possible to define a transformation between operating room coordinates and the coordinates of the image.

More recently, a number of systems have been proposed in which the accuracy of the 3-D diagnostic data image sets is exploited to enhance accuracy of operating room images, by matching these 3-D images to patterns appearing in intraoperative fluoroscopic images. These systems may use tracking and matching edge profiles of bones, morphologically deforming one image onto another to determine a coordinate transform, or other correlation process. The procedure of correlating the lesser quality and non-planar fluoroscopic images with planes in the 3-D image data sets may be time-consuming. In techniques that use fiducials or added markers, a surgeon may follow a lengthy initialization protocol or a slow and computationally intensive procedure to identify and correlate markers between various sets of images. All of these factors have affected the speed and utility of intraoperative image guidance or navigation systems.

Correlation of patient anatomy or intraoperative fluoroscopic images with precompiled 3-D diagnostic image data sets may also be complicated by intervening movement of the imaged structures, particularly soft tissue structures, between the times of original imaging and the intraoperative imaging procedure. Thus, transformations between three or more coordinate systems for two sets of images and the physical coordinates in the operating room may involve a large number of registration points to provide an effective correlation. For spinal tracking to position pedicle screws, the tracking assembly may be initialized on ten or more points on a single vertebra to achieve suitable accuracy. In cases where differing patient positioning or a changing tissue characteristic like a growing tumor actually changes the tissue dimension or position between imaging sessions, further confounding factors may appear.

When the purpose of image guided tracking is to define an operation on a rigid or bony structure near the surface, as is the case in placing pedicle screws in the spine, the registration may alternatively be effected without ongoing reference to tracking images, by using a computer modeling procedure in which a tool tip is touched to and initialized on each of several bony prominences to establish their coordinates and disposition, after which movement of the spine as a whole is modeled by optically initially registering and then tracking the tool in relation to the position of those prominences, while mechanically modeling a virtual representation of the spine with a tracking element or frame attached to the spine. Such a procedure dispenses with the time-consuming and computationally intensive correlation of different image sets from different sources, and, by substituting optical tracking of points, may eliminate or reduce the number of x-ray exposures used to effectively determine the tool position in relation to the patient anatomy with the reasonable degree of precision.

Thus, it remains highly desirable to utilize simple, low-dose and low cost fluoroscope images for surgical guidance, yet also to achieve enhanced accuracy for critical tool positioning.

In medical imaging, picture archiving and communication systems (PACS) are computers or networks dedicated to the storage, retrieval, distribution and presentation of images. Full PACS handle images from various modalities, such as ultrasonography, magnetic resonance imaging, positron emission tomography, computed tomography, endoscopy, mammography and radiography.

Registration is a process of correlating two coordinate systems, such as a patient image coordinate system and an electromagnetic tracking coordinate system. Several methods may be employed to register coordinates in imaging applications. “Known” or predefined objects are located in an image. A known object includes a sensor used by a tracking system. Once the sensor is located in the image, the sensor enables registration of the two coordinate systems.

U.S. Pat. No. 5,829,444 by Ferre et al., issued on Nov. 3, 1998, refers to a method of tracking and registration using a headset, for example. A patient wears a headset including radio-opaque markers when scan images are recorded. Based on a predefined reference unit structure, the reference unit may then automatically locate portions of the reference unit on the scanned images, thereby identifying an orientation of the reference unit with respect to the scanned images. A field generator may be associated with the reference unit to generate a position characteristic field in an area. When a relative position of a field generator with respect to the reference unit is determined, the registration unit may then generate an appropriate mapping function. Tracked surfaces may then be located with respect to the stored images.

However, registration using a reference unit located on the patient and away from the fluoroscope camera introduces inaccuracies into coordinate registration due to distance between the reference unit and the fluoroscope. Additionally, the reference unit located on the patient is typically small or else the unit may interfere with image scanning. A smaller reference unit may produce less accurate positional measurements, and thus impact registration.

Typically, a reference frame used by a navigation system is registered to an anatomy prior to surgical navigation. Registration of the reference frame impacts accuracy of a navigated tool in relation to a displayed fluoroscopic image.

Additionally, there is a desire to reduce the amount of ionizing radiation a patient is exposed to during a medical procedure. Previous methods of medical device navigation utilized continuous fluoroscopic imaging as a device as is moved through a patient's anatomy. Each fluoroscopic image may increase the effective dose a patient receives. Thus a technique that reduces the overall amount of fluoroscopic imaging and thus the dose received is especially desirable.

Furthermore, there is a desire for an improved method of sinuplasty navigation. Specifically, a navigation method that does not rely on fiducials, surface markers, headsets or manual navigation. Previous methods of sinuplasty navigation relied on endoscopic visual or fluoroscopic observation of the sinuplasty navigation.

Thus, there is a need for a medical navigation system with a simplified image registration procedure, lower radiation doses, improved image registration accuracy, and reduced time for a medical navigation procedure.

### SUMMARY OF THE INVENTION

Certain embodiments of the present invention provide systems and methods of improved medical device navigation. Certain embodiments include a system for acquiring a first image of a patient anatomy, a second image of patient anatomy, and creating a registered image by utilizing image based registration techniques applied to the first and second images. Other embodiments teach systems and methods for navigating a sinuplasty device within a patient anatomy using one or more registered images.

These and other features of the present invention are discussed or apparent in the following detailed description.

### BRIEF DESCRIPTION OF THE DRAWINGS

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

FIG. 1 illustrates a sinuplasty system used in accordance with an embodiment of the present invention.

FIGS. 2A, 2B, and 2C illustrate the use of a sinuplasty device in accordance with an embodiment of the invention.

FIG. 3 illustrates an exemplary surgical navigation system used in accordance with an embodiment of the present invention.

FIG. 4 illustrates an exemplary display device used in accordance with an embodiment of the present invention.

FIG. 5 illustrates a medical navigation system according to an embodiment of the present invention.

FIG. 6 illustrates a method of navigating a medical device according to an embodiment of the present invention.

### DETAILED DESCRIPTION OF THE PREFERRED EMBODIMENTS

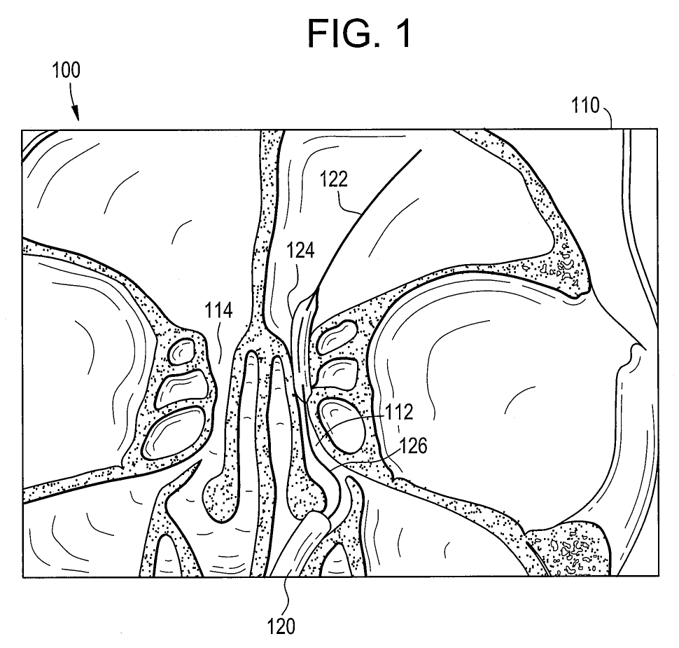

FIG. 1 illustrates an exemplary sinuplasty system 100 as used in accordance with an embodiment of the present invention. The sinuplasty system 100 includes a sinuplasty device 120, a guide wire 122, catheter balloon 124, and cannula 126. The sinuplasty system 100 illustrated in FIG. 1 is located inside the cranial region 110 of a patient. The patient's cranial region 110 further includes a sinus passageway 112 and a sinus passageway 114. More specifically, the sinuplasty device 120 is located in the patient's sinus passageway 112. A sinus passageway may also be known as an ostium. The sinuplasty device 120 contains several components, including the guide wire 122, the catheter balloon 124, and the cannula 126.

Sinuplasty is a medical procedure utilizing a device to enlarge a sinus passageway of a patient. More specifically, as illustrated in the simplified example of FIG. 1, the sinuplasty device 120 is inserted into the cranial region 110 of a patient. The sinuplasty device 120 may be inserted through a nostril of the patient. The sinuplasty device 120 uses the guide wire 122 to enter the sinus passageway 112. To gain initial sinus access, the sinuplasty device 120 can enter the patient anatomy under endoscopic visualization. After the guide wire 122 reaches the sinus passageway 112, the sinuplasty device 120 guides the catheter balloon 124 into the sinus passageway 112. The catheter balloon 124 tracks smoothly over the guide wire 122 to reach the blocked or constricted sinus passageway 112. After the catheter balloon enters the sinus passageway 112, the sinuplasty device 120 inflates the catheter balloon 124. As the catheter balloon 124 expands, the enlarged catheter balloon 124 comes into contact with the sinus passageway 112. The sinuplasty device 120 continues to inflate the catheter balloon 124 further placing pressure on the sinus passageway 112. The increased pressure from the dilated catheter balloon 124 forces the interior volume of the sinus passageway 112 to expand. After the sinus passageway 112 has been sufficiently enlarged, the sinuplasty device 120 deflates the catheter balloon 124. Then the sinuplasty device 120, including guide wire 122 and catheter balloon 124 are withdrawn from the patient's cranial region 110. The sinus passageway 112 remains enlarged ever after the catheter balloon 124 has been deflated and removed. The restructured sinus passageway 112 allows for normal sinus function and drainage.

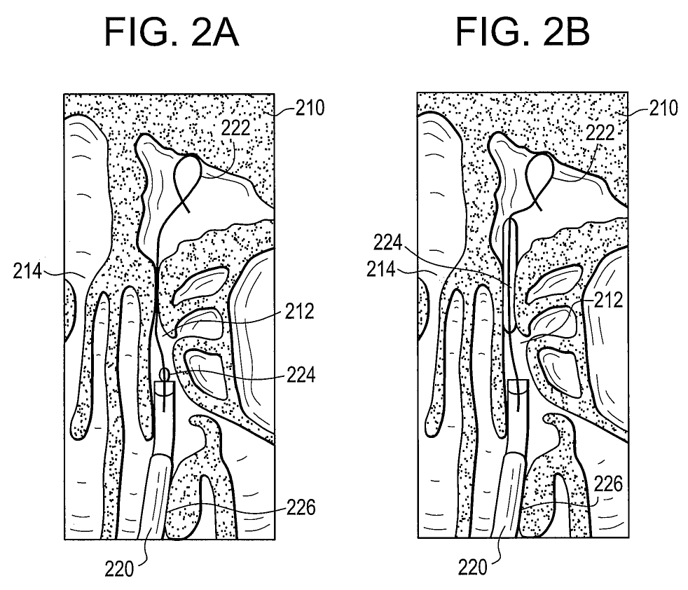

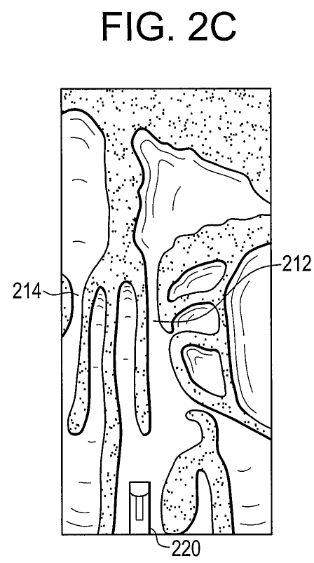

FIGS. 2A, 2B, and 2C illustrate the use of a sinuplasty device 220 in accordance with an embodiment of the invention. The sinuplasty device 220 used in FIGS. 2A, 2B, and 2C is similar to the device illustrated in FIG. 1. The sinuplasty device 220 includes a guide wire 222, a catheter balloon 224, and a cannula 226. The patient's cranial region 210 further includes a sinus passageway 212 and a sinus passageway 214. As shown in FIG. 2A, the sinus passageway 212 is constricted and narrow whereas the sinus passageway 214 is relatively open and healthy. More specifically, sinuplasty device 220 is located in the patient's sinus cavity 212.

Similar to FIG. 1 described above, the sinuplasty device 220 may be inserted into a patient's cranial region. As shown in FIG. 2A, the guide wire 222 passes through the constricted sinus passageway 212. Next, the sinuplasty device 220 directs the balloon catheter 224 along the guide wire 222 into the constricted sinus passageway 212.

FIG. 2B illustrates the enlargement of the constricted sinus passageway 212. After balloon catheter 224 enters the constricted sinus passageway 212, the sinuplasty device 220 inflates the balloon catheter 224. As shown in FIG. 2B, the increased volume of balloon catheter 224 places pressure on the interior of the sinus passageway 212. The increasing pressure from balloon catheter 224 pushes against the interior walls of the constricted sinus passageway 212 and forces the constricted sinus passageway 212 to expand. After the balloon catheter 224 has been dilated for a sufficient time, the sinuplasty device 220 deflates the catheter balloon 224.

FIG. 2C illustrates the effect on a constricted sinus passageway 212 after using the sinuplasty device 220 to perform a sinuplasty procedure. As shown in FIG. 2C, the guide wire 222 and the balloon catheter 224 have been removed from constricted sinus passageway 212. However, unlike in FIG. 2A, the sinus passageway 212 is no longer constricted. Even after the sinuplasty device 220 has been removed, the sinus passageway 212 remains relatively open, like the sinus passageway 214.

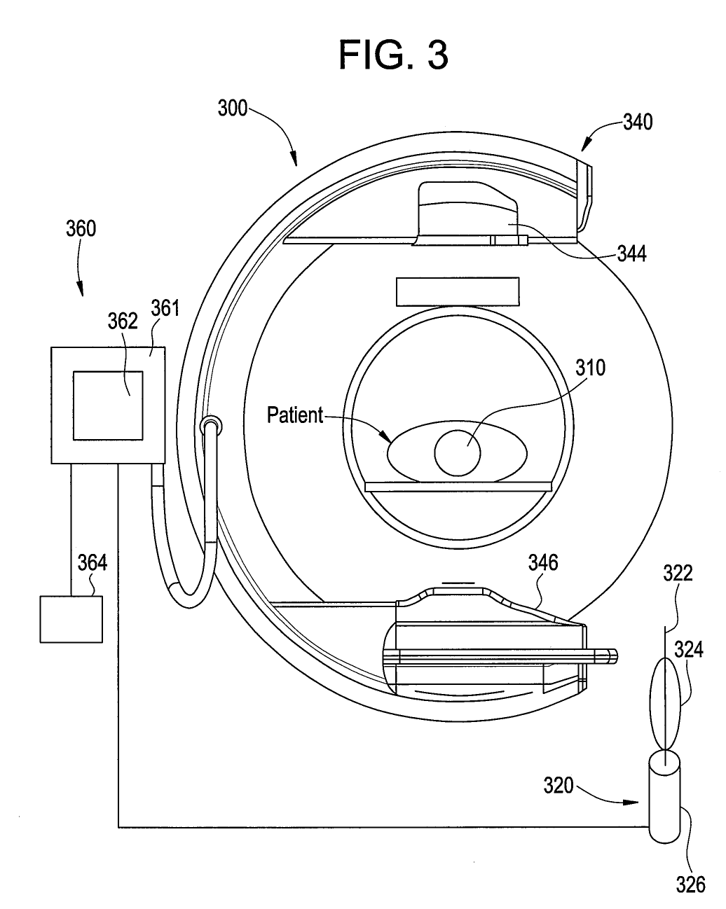

FIG. 3 illustrates an exemplary surgical navigation system used in accordance with an embodiment of the present invention. More specifically, a surgical navigation system used in a variety of ear, nose, and throat (ENT) surgeries or other cranial procedures. The embodiment illustrated in FIG. 3 can also be used for medical procedures in other areas of a patient's anatomy.

The surgical navigation system 300 includes a sinuplasty device 320, a medical imaging modality 340, and a workstation 360. The sinuplasty device further includes a cannula 322 and a balloon catheter 324. The medical imaging modality 340 further includes a C-arm 342, an imager 344, and a receiver 346. The workstation 360 further includes an image processor 361, a display 362, and an input device 364. Also shown in FIG. 3 is a patient with a cranial region 310.

The sinuplasty device 320 includes a guide wire 322, a balloon catheter 324, and a cannula 326, similar to the device described above. The sinuplasty device 320 may optionally contain an endoscope camera. The sinuplasty device 320 also operates similar to the device described above.

The medical imaging modality 340 can be any type of medical imaging device capable of acquiring images of a patient's modality. The medical imaging modality 340 can optionally acquire images through a plurality of different imaging modalities. In one example the medical imaging modality 340 includes a fluoroscope imager 344 and a fluoroscope receiver 346 mounted opposite the fluoroscope imager 344 on the C-arm 342. In another example, the medical imaging modality further includes a 3D dataset imager 344 and a 3D dataset receiver 346. The medical imaging modality 340 is capable of acquiring preoperative, intraoperative, and postoperative image data.

The medical imaging modality 340 can direct the C-arm 342 into a variety of positions. The C-arm 342 moves about a patient or other object to produce images of the patient from different angles or perspectives. At a position, the imager 344 and receiver 346 can acquire an image of a patient's anatomy. The C-arm is capable of moving into a variety of positions in order to acquire 2D and 3D images of the patient's anatomy. Aspects of imaging system variability may be addressed using tracking elements in conjunction with a calibration fixture or correction assembly to provide fluoroscopic images of enhanced accuracy for tool navigation and workstation display.

The workstation 360 can include an image processor 361, a display 362, and an input device 364. The components of workstation 360 can be integrated into a single device or they may be present in a plurality of standalone devices. The image processor 361 can perform several functions. First, the image processor 361 can direct the medical imaging modality 340 to acquire imaging data of a patient's anatomy. Furthermore, the image processor 361 can communicate with a PACS system to store and retrieve image data. Moreover, the image processor 361 can provide data to the display 362 described below. Finally, the image processors may perform a variety of image processing functions. These functions can include 2D/3D image processing, navigation of a 3D dataset of a patient anatomy, and image registration.

The image processor 361 may create a 3D model or representation from an imaging source acquiring a 3D dataset of a patient anatomy. The image processor 361 can communicate with display 362 to display the 3D representation on display 362. The image processor 361 can perform operations on 2D/3D image data in response to user input. For example, the image processor may calculate different views and perspectives of the 3D dataset to allow a user to navigate the 3D space.

The image processor 361 can register one or more 2D images to a 3D dataset of a patient's anatomy. For example, one or more 2D fluoroscopic still images may be registered to a 3D CT dataset of a patient's cranial region. In one embodiment, the registration of the 2D images to the 3D dataset is automatic. One advantage of this embodiment is the ability to register more than one set of medical imaging data without the use of fiducial markers, a headset, or manual registration. Automatic image registration performed by the image processor 361 can reduce the amount of time required to register the image datasets. Additionally, automatic image-based registration can result in improved accuracy compared to the use of other registration techniques.

The display 362 can operate to display one or more images during a medical procedure. The display 362 may be integrated with the workstation 360 or it may also be a standalone unit. The display 362 can present a variety of images from a variety of imaging modalities. In one example, the display 362 may be used to provide video from an endoscope camera. In other examples, the display 362 may provide a 2D view of a 3D image dataset. In another example, the display 362 may provide fluoroscopic image data in the form of static fluoroscope images or fluoroscopic video. In yet another example, the display 362 may provide a combination of images and image data types. Further examples and embodiments of displays are described below.

The input device 364 of workstation 360 can be a computer mouse, keyboard, joystick, microphone or any device used by an operator to provide input to a workstation 360. An operator may be a human or a machine. Input device can be used to navigate a 3D dataset of a patient anatomy, alter the display 362, or control a surgical device such as the sinuplasty device 320.

The components of the surgical navigation system 300 may communicate via wired and/or wireless communication, for example, and may be separate systems and/or integrated to varying degrees, for example.

The workstation 360 can communicate with the medical imaging modality 340 through wired and/or wireless communication. For example the workstation 360 can control the actions of the medical imaging modality 340. Additionally, the medical imaging modality 340 can provide acquired image data to the workstation 360. One example of such communication is over a computer network. Moreover, the medical imaging modality 340 and the workstation 360 can communicate with a PACS system. Furthermore, the medical imaging modality 340, the workstation 360, and the PACS system can be integrated to varying degrees.

In another example, the workstation 360 can connect to the sinuplasty device 320. More specifically, the sinuplasty device 320 can connect to the workstation 360 through any electrical or communication link. The sinuplasty device 320 can provide video or still images from an attached endoscope to the workstation 360. Additionally, the workstation 360 can send control signals to the sinuplasty device 320, instructing the balloon catheter 324 to inflate and/or deflate.

The surgical navigation system 300 tracks, directs, and/or guides a medical instrument located within a patient's body. More specifically, as illustrated in FIG. 3, the surgical navigation system 300 can track, direct, and/or guide a medical device used in an ENT procedure or other surgery. A user may operate the workstation 360 to view imaging data of the surgical device in relation to the patient anatomy. In addition, the user may control the movement of the surgical device within the patient anatomy through the workstation 360. Alternatively, the user may manually control the movement of the surgical device. The display 362 can display the position of the surgical device within the patient anatomy.

In operation, a preoperative imaging modality obtains one or more preoperative images of a patient anatomy. The preoperative imaging modality may include any device capable of capturing an image of a patient anatomy such as a medical diagnostic imaging device. In one embodiment, the preoperative imaging modality acquires one or more preoperative 3D dataset of a patient's cranial region 310. The preoperative 3D dataset may be acquired by a variety of imaging modalities including Computed Tomography and Magnetic Resonance. The preoperative 3D dataset is not limited to any particular imaging modality. Similarly, the preoperative imaging modality may also acquire one or more preoperative 2D images of a patient's cranial region 310. The preoperative 2D images may be acquired by a variety of imaging modalities including fluoroscope. Alternatively, the preoperative images described above may instead be acquired during the course of a medical procedure or surgery

The preoperative imaging may be stored on a computer or any other electronic medium. Specifically, the preoperative 3D datasets and preoperative 2D images may be stored on the workstation 360, a PACS system, or any other storage device.

The medical imaging modality 340 acquires one or more intraoperative images of the patient anatomy. Specifically, the medical imaging modality 340 acquires one or more intraoperative fluoroscopic images of the patient's cranial region 310 from one more or positions of the C-arm 342.

The intraoperative fluoroscopic images of the patient's cranial region 310 are communicated to the workstation 360. Additionally, the workstation 360 accesses the preoperative 3D dataset of the patient's cranial region 310. Then, the image processor 361 aligns the intraoperative fluoroscopic images with the preoperative 3D dataset.

The image processor 361 aligns the 3D dataset with the fluoroscopic images using image based registration techniques. As stated above, the registration can be automatic, based on the features of the image data. The image processor 361 can use a variety of image registration techniques. The original image is often referred to as the reference image and the image to be mapped onto the reference image is referred to as the target image.

The image processor 361 may use label-based registration techniques comparing identifiable features of a patient anatomy. Label-based techniques can identify homologous structures of the plurality of datasets and find a transformation that best superposes identifiable points of the images. The image processor 361 can also use non-label-based registration techniques. Non-label-registration techniques can perform a spatial transformation minimizing the index of difference between image data. The image processor may also use rigid and/or elastic registration techniques to register the image datasets. Additionally, the image processor may use similarity measure registration algorithms such as maximum likelihood, approximate maximum likelihood, Kullback-Leibler divergence, and mutual information. The image processor 361 may also use a grayscale based image registration technique.

The image processor 361 may also use area based methods and feature based methods. For area based image registration methods, the algorithm looks at the structure of the image via correlation metrics, Fourier properties and other means of structural analysis. However, most feature based methods, instead of looking at the overall structure of images, fine tunes its mapping to the correlation of image features: lines, curves, points, line intersections, boundaries, etc.

Image registration algorithms can also be classified according to the transformation model used to relate the reference image space with the target image space. The first broad category of transformation models includes linear transformations, which are a combination of translation, rotation, global scaling, shear and perspective components. Linear transformations are global in nature, thus not being able to model local deformations. Usually, perspective components are not needed for registration, so that in this case the linear transformation is an affine one.

The second category includes ‘elastic’ or ‘nonrigid’ transformations. These transformations allow local warping of image features, thus providing support for local deformations. Nonrigid transformation approaches include polynomial warping, interpolation of smooth basis functions (thin-plate splines and wavelets), and physical continuum models (viscous fluid models and large deformation diffeomorphisms).

Image registration methods can also be classified in terms of the type of search that is needed to compute the transformation between the two image domains. In search-based methods the effect of different image deformations is evaluated and compared. In direct methods, such as the Lucas Kanade method and phase-based methods, an estimate of the image deformation is computed from local image statistics and is then used for updating the estimated image deformation between the two domains.

Another useful classification is between single-modality and multi-modality registration algorithms. Single-modality registration algorithms are those intended to register images of the same modality (i.e. acquired using the same kind of imaging device), while multi-modality registration algorithms are those intended to register images acquired using different imaging devices.

Image similarity-based methods are broadly used in medical imaging. A basic image similarity-based method consists of a transformation model, which is applied to reference image coordinates to locate their corresponding coordinates in the target image space, an image similarity metric, which quantifies the degree of correspondence between features in both image spaces achieved by a given transformation, and an optimization algorithm, which tries to maximize image similarity by changing the transformation parameters.

The choice of an image similarity measure depends on the nature of the images to be registered. Common examples of image similarity measures include Cross-correlation, Mutual information, Mean-square difference and Ratio Image Uniformity. Mutual information and its variant, Normalized Mutual Information, are the most popular image similarity measures for registration of multimodality images. Cross-correlation, Mean-square difference and Ratio Image Uniformity are commonly used for registration of images of the same modality.

After the image processor 361 has registered a plurality of image data, a surgical device may be navigated and tracked in patient's anatomy. More specifically, after the fluoroscopic images have been registered to the 3D dataset, the sinuplasty device 320 can be navigated simultaneously on the fluoroscopic images and the 3D dataset. As the device is moved within the patient's anatomy, the image processor 361 may update the position of the sinuplasty device 320 as displayed in the 3D space resulting from registering the fluoroscopic images to the 3D dataset.

During a medical procedure, further intraoperative imaging may be acquired. The additional intraoperative images can also be registered to the existing 3D space resulting from the earlier registration of two sets of image data. For example, additional fluoroscope images may be taken after a sinuplasty procedure has begun. These updated fluoroscopic images may be registered to the existing 3D space created from registering the earlier fluoroscopic images to the preoperative CT dataset. This updated re-registration, can improve the accuracy of the 3D space used to navigate the sinuplasty device 320.

During the sinuplasty procedure, the sinuplasty device 320 is navigated to the appropriate location. As described above, the balloon catheter 324 is inflated to dilate the sinus passageway. During the inflation of the balloon catheter 324, the imager 342 may acquire live fluoroscopic imaging. The live fluoroscopic imaging can be displayed on the display 362 to allow a user to monitor the dilation as it occurs. The live fluoroscopic imaging can also be used to update the 3D space through reregistration. Next, the user operates the balloon catheter 324 to cease inflation and begin deflation. After the balloon catheter 324 has deflated, the sinuplasty device 320 may be removed. Additional fluoroscopic images may be acquired to view the patient's anatomy after the removal of the sinuplasty device 324 to ensure the procedure was successful. Previous methods of medical device navigation relied on live, continuous fluoroscopic video imaging throughout the entire medical procedure. An embodiment of the medical navigation system 300 only uses one or more still fluoroscopic shots to navigate the medical device. One advantage of this improved system embodiment is a lower overall effective dose of ionizing radiation.

The surgical navigation system 300 is not limited to use with a sinuplasty device 320. Instead, the surgical navigation system 300 illustrated in FIG. 3 may be used to track and navigate any medical device that may be placed inside a patient's anatomy. For example, once registration is performed, surgical tools, cannulas, catheters, endoscopes or any other surgical device can be navigated within a patient anatomy simultaneously on the fluoroscopic images and the 3D dataset. Additionally, the surgical navigation system 300 can be used in any area of a patient's anatomy, not just a patient's cranial region 310.

In an alternative embodiment, the sinuplasty device 320 may be operated by a mechanical device, such as a robotic arm. For example, a surgeon may use an input device 364 attached to computer 360 to direct a control the robotic arm. In turn, the robotic arm can control the movement of the sinuplasty device 320.

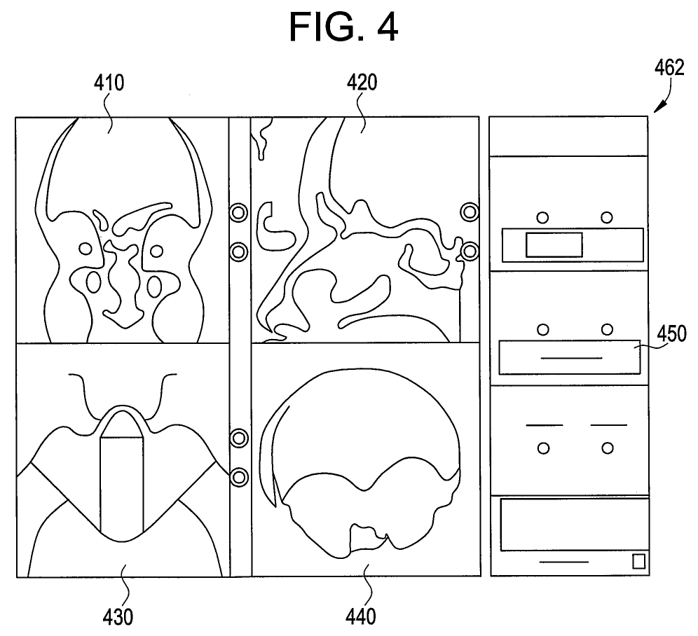

FIG. 4 illustrates an exemplary display device used in accordance with an embodiment of the present invention. The display 462 may operate similar to displays described above. Display device 462 can further include window 410, window 420, window 430, window 440, and window 450. The windows of display device 462 can provide a variety of visual information to a user. For example, the windows may display anteroposterior, lateral, and axial views from a variety of imaging modalities including CT, MR or fluoroscope, rendered 3D views, and endoscopic pictures or video. Additionally, the display 362 may provide textual data relating to the medical procedure. As shown in FIG. 4, the window 410 provides an anteroposterior CT view, the window 420 provides a lateral CT view, the window 430 provides an axial CT view, the window 440 provides a fluoroscope view, and the window 450 provides textual data relating to the medical procedure.

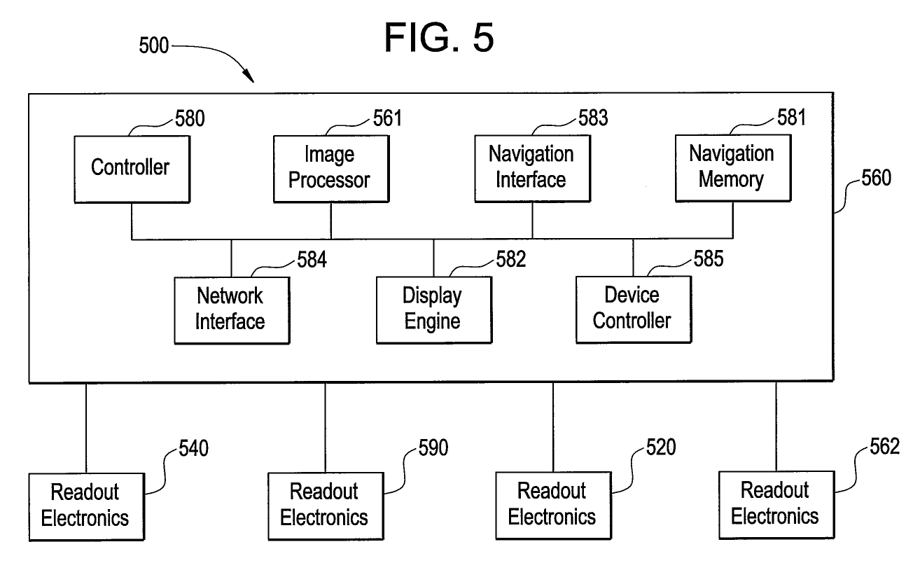

FIG. 5 illustrates a medical navigation system 500 according to an embodiment of the invention. The navigation system 500 comprises a workstation 560, an imaging modality 540, a PACS 590, a surgical device 520, and a display 562. The workstation 560 further comprises a controller 580, a memory 581, a display engine 582, a navigation interface 583, a network interface 584, a surgical device controller 585, and an image processor 561. The workstation 560 is illustrated conceptually as a collection of modules, but may be implemented using any combination of dedicated hardware boards, digital signal processors, field programmable gate arrays, and processors. Alternatively, the modules may be implemented using an off-the-shelf computer with a single processor or multiple processors, with the functional operations distributed between the processors. As an example, it may be desirable to have a dedicated processor for image registration calculations as well as a dedicated processor for visualization operations. As a further option, the modules may be implemented using a hybrid configuration in which certain modular functions are performed using dedicated hardware, while the remaining modular functions are performed using an off-the-shelf computer. A controller 580 may control the operations of the modules. The controller 580, memory 581, display engine 582, navigation interface 583, network interface 584, surgical device controller 585, and image processor 561 are modules of the workstation 560. As such, the modules are in communication with each other through a system bus of the workstation 560. The system bus may be PCI, PCIe, or any other equivalent system bus.

As shown in FIG. 5, the workstation 560 communicates with the imaging modality 540, the PACS 590, the surgical device 520, and the display 562. The communication may be any form of wireless and/or wired communication. The controller 580 of workstation 560 may operate the network interface 584 to communicate with other elements of system 500. For example, the network interface 584 may be a wired or wireless Ethernet card communicating with the PACS 590 or imaging modality 540 over a local area network.

In operation, the workstation 560 operates to navigate the surgical device 520. More specifically, the workstation 560 utilizes image processor 561 to register a plurality of image data sets and then navigate the surgical device in the registered image space. In one example, an imaging modality acquires one or more preoperative images of a patient anatomy. In a preferred embodiment, the preoperative images comprise 3D data. Specifically, Computed Tomography or Magnetic Resonance images of the patient anatomy. The preoperative images may be stored on the PACS 590.

During a medical procedure, a user may operate the workstation 560 to navigate the surgical instrument 520 in the patient's anatomy. The user may operate the workstation through a mouse, keyboard, trackball, touchscreen, voice-activated commands, or any other input device. The controller 580 begins the navigation process by accessing the preoperative image data. The controller 580 instructs the network interface 584 to retrieve the preoperative image data from PACS 590. The controller 580 loads the preoperative image data into memory 581. Memory 581 may be RAM, flash memory, a hard disc drive, tape, CD-ROM, DVD or any other suitable data storage medium.

Next, a user may operate the surgical device 520 to perform a medical procedure on a patient. In a typical embodiment, a user places the surgical device 520 within the patient's anatomy. The workstation 560 may operate to display views of the surgical device 520 within the patient anatomy. The controller 580 communicates with imaging modality to acquire intraoperative image data of the patient anatomy. In one example, the imaging modality 540 comprises a fluoroscope positioned on a C-arm. The controller 580 instructs the imaging modality to acquire one or more fluoroscopic images at one or more positions of the C-arm. The imaging modality 540 communicates the intraoperative image data to the controller 580. The intraoperative image data may include images of the surgical device 520 within the patient anatomy. The communication between imaging modality 540 and controller 580 may pass through the network interface 584, or any other interface of workstation 540 used for communicating with other devices. An interface may be a hardware device or software.

The controller 580 places the intraoperative imaging data in memory 581. The controller 580 commands the image processor 561 to perform imaging functions on the preoperative and the intraoperative image data. For example, the controller 580 may instruct the image processor to register the one or more intraoperative fluoroscope images to the preoperative CT image data set. The image processor 561 registers the preoperative and the postoperative image data using the image registration techniques described elsewhere in the present application. In a preferred embodiment, the image registration is image based, without the use of fiducial markers, headsets, or manual input from a user. The image registration may also occur automatically, without input from a user. For example, when intraoperative images are acquired, the image processor 561 may register the intraoperative images to preoperative image without further input from the user. In another example, if further intraoperative images are acquired, the image processor 361 may reregister the newly acquired intraoperative images to the preexisting registered image without further input from the user. The image processor 561 creates a registered image as a result of the image registration. In one example, the registered image may be a 3-D image indicating the position of the surgical device 520 within the patient anatomy. The image processor 561 communicates the registered image to the display engine 582.

The navigation interface 583 may operate to control various aspects relating to navigating the surgical device 520 within the patient anatomy. For example, the navigation interface 583 may request the controller 580 to acquire additional intraoperative images from imaging modality 540. The navigation interface 583 may request additional intraoperative imaging based on a user input, a time interval, a position of the surgical device 520, or any other criteria. Furthermore, a user may operate navigation interface 583 to request continuous intraoperative imaging. Examples of continuous intraoperative imaging may include, live fluoroscopic video imaging or video provided by an endoscope camera device. A user may also operate navigation interface 583 to alter the format, style, viewpoint, modality, or other characteristic of the image data displayed by the display 562. The navigation interface 583 may communicate these user inputs to the display engine 582.

The display engine 582 provides visual data to display 562. The display engine 582 may receive a registered image from image processor 561. The display engine then provides graphical output related to the registered image or any other available display data. For example, the display engine 582 may render a 3D image based on the registered image. The display engine 582 may output the rendered 3D image or a rendered three planes view of the rendered 3D image to the display 562. The display engine 582 may output display views of the registered image from any perspective. Additionally, the display engine 582 may output video, graphics, or textual data relating to the medical procedure.

In an alternate embodiment, the navigation interface 583 may communicate with the surgical device 520. Specifically, the surgical device may contain a positioning sensor capable of measuring changes in the position of the surgical device 520. The positioning sensor may be an electromagnetic or inertial sensor. When the surgical device 520 changes position, the positioning sensor may communicate data to navigation interface 583. The navigation interface 583 calculates the change in position based on the data received from the sensor. Alternatively, the positioning sensor may be integrated with a processor to calculate the change in position and provide the updated position to the navigation interface 583. The navigation interface 583 provides data relating to the change in position of surgical device 520 to the image processor 561. The image processor 561 operates to the update the position of the surgical device 520 within the registered image based on the data relating to the change in position.

In another alternative embodiment the medical navigation system 500 comprises a portable workstation 560 with a relatively small footprint (e.g., approximately 1000 cm²). According to various alternate embodiments, any suitable smaller or larger footprint may be used. The display 562 may be integrated with the workstation 562. Various display configurations may be used to improve operating room ergonomics, display different views, or display information to personnel at various locations. For example, a first display may be included on the medical navigation system, and a second display that is larger than the first display is mounted on a portable cart. Alternatively, one or more of the displays may be mounted on a surgical boom. The surgical boom may be ceiling-mounted, attachable to a surgical table, or mounted on a portable cart.

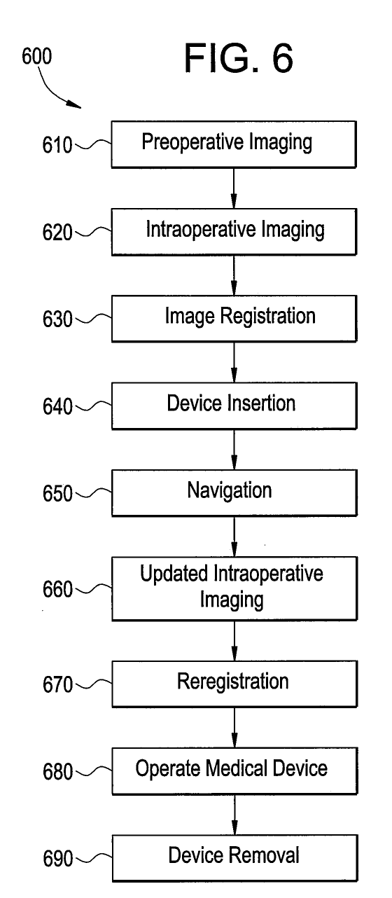

FIG. 6 illustrates a method of navigating a medical device according to an embodiment of the present invention. First, at step 610, preoperative images are acquired of a patient anatomy. As described above, the preoperative image data may be a 3D imaging modality such as Computed Tomography or Magnetic Resonance imaging. The preoperative image data may be stored on a PACS.

Next, at step 620, intraoperative images are acquired of the patient anatomy. During the medical procedure, further image data may be acquired. For example, a fluoroscope imaging device mounted on a C-arm may acquire one or more images of a patient anatomy.

At step 630, the intraoperative image data is registered to the preoperative image data. The preoperative image data and the intraoperative data are registered using the image registration techniques described above. For example, an imaging workstation may apply image based registration techniques to the preoperative and intraoperative image data to create a registered image. In one example the registered image comprises 3D image data of the patient anatomy. The preoperative imaging data may be retrieved from a PACS system.

A medical device is placed within the patient anatomy at step 640. The medical device may be any instrument used in a medical procedure. In one example, the medical device is a sinuplasty device as described above.

The medical device is navigated within the patient anatomy at step 650. The above-mentioned registered image of the patient anatomy is displayed on a display device. Furthermore, the position of the medical device within the patient anatomy is indicated in the registered image. The medical device may be moved within the patient anatomy. As the position of the medical device within the patient anatomy changes, the position of the medical device within the registered image also changes.

At step 660, updated intraoperative imaging data may be acquired. At any time after a registered image is created, additional intraoperative image data may be acquired. For example, additional intraoperative image data may be acquired after the medical device is inserted within the patient anatomy. In another example, additional intraoperative image data is acquired before a medical device is operated.

Next, at step 670, the updated intraoperative image data is registered to the image data previously registered in step 630. The additional intraoperative image data acquired in step 660 is reregistered to the registered image created in step 630. This creates an updated registered image. The updated registered image may provide a more accurate image of the patient anatomy and the position of the medical device within the patient anatomy. A plurality of intraoperative images relating to a plurality of imaging modalities may be acquired and reregistered to a registered image.

Then, at step 680, a medical device is operated within the patient anatomy. As described above, the medical device may be any medical or surgical instrument placed within a patient anatomy. In a specific example, the medical device may be a sinuplasty device. In operation, the sinuplasty device is navigated to a constricted or obstructed sinus passageway within the patient cranial region. After the sinuplasty device has been navigated using the registered image to the desired location, an imaging modality may acquire additional intraoperative images to create an updated registered image. The updated registered image verifies that the sinuplasty device has been successfully navigated to the desired location. Next the sinuplasty device begins operation. Specifically, the balloon catheter dilates to expand the constricted sinus passageway. After the sinuplasty device expands the sinus passageway, the sinuplasty device is deflated. In one example, a fluoroscope may provide live fluoroscopic imaging during the inflation and deflation process.

Finally, at step 690, the medical device is removed from within the patient anatomy. The medical device may be navigated using updated registered images during the removal process.

There are several alternative embodiments of the described method. In one embodiment, preoperative images are not acquired. Instead, more than one intraoperative image is acquired. In another embodiment, intraoperative images are acquired after a medical device has been placed within the patient anatomy. In other embodiments, further intraoperative images are acquired after the operation of sinuplasty device and after the removal of the sinuplasty device.

In alternate embodiments, one or more of the steps listed in FIG. 6 may be eliminated. Additionally, the steps listed in FIG. 6 are not limited to the particular order in which they are described.

As will be described further below, certain embodiments of the present invention provide intraoperative navigation on 3D computed tomography (CT) datasets, such as the critical axial view, in addition to 2D fluoroscopic images. In certain embodiments, the CT dataset is registered to the patient intra-operatively via correlation to standard anteroposterior and lateral fluoroscopic images. Additional 2D images can be acquired and navigated as the procedure progresses without the need for re-registration of the CT dataset.

Certain embodiments provide tools enabling placement of multilevel procedures. Onscreen templating may be used to select implant length and size. The system may memorize the location of implants placed at multiple levels. A user may recall stored overlays for reference during placement of additional implants. Additionally, certain embodiments help eliminate trial-and-error fitting of components by making navigated measurements. In certain embodiments, annotations appear onscreen next to relevant anatomy and implants.

Certain embodiments utilize a correlation based registration algorithm to provide reliable registration. Standard anteroposterior and lateral fluoroscopic images may be acquired. A vertebral level is selected, and the images are registered. The vertebral level selection is accomplished by pointing a navigated instrument at the actual anatomy, for example.

Thus, certain embodiments aid a surgeon in locating anatomical structures anywhere on the human body during either open or percutaneous procedures. Certain embodiments may be used on lumbar and/or sacral vertebral levels, for example. Certain embodiments provide DICOM compliance and support for gantry tilt and/or variable slice spacing. Certain embodiments provide auto-windowing and centering with stored profiles. Certain embodiments provide a correlation-based 2D/3D registration algorithm and allow real-time multiplanar resection, for example.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical navigation system. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

One or more of the embodiments of the present invention provide improved systems and methods of improved medical device navigation. Specifically, an embodiment provides for a system with automated registration of a plurality of imaging modalities. The embodiments teach systems and methods of image registration without the use of fiducial markers, headsets, or manual registration. Thus the embodiments teach a simplified method of image registration in a reduced amount of time that allows a medical device to be navigated within a patient anatomy. Furthermore, the embodiments teach navigating a medical device in a patient anatomy with reduced fluoroscopic images resulting in lowered radiation doses experienced by patients. Additionally, the improved systems and methods of image registration provide for improved accuracy of the registered images.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for registering images of a patient cranial anatomy, said system comprising:
a first imager generating a first image of a patient cranial anatomy;
a second imager generating a second image of said patient cranial anatomy, wherein said second imager comprises an imaging modality different than said first imager;
a medical device inserted within said patient cranial anatomy;
an image processor registering said first image to said second image to create a registered image of said patient cranial anatomy; and
a display device displaying the position of said medical device in relation to said registered image.

2. The system of claim 1, wherein said second imager generates a third image of said patient cranial anatomy and said image processor modifies said registered image based on said third image.

3. The system of claim 1, wherein said second imager generates a third image of said patient cranial anatomy and said image processor registers said registered image to said third image to create a reregistered image of said patient cranial anatomy.

4. The system of claim 1, wherein said first imager is three dimensional imager and said second imager is a two dimensional imager.

5. The system of claim 1, wherein said first imager is a CT imager and said second imager is a fluoroscopic imager.

6. The system of claim 1 wherein said image processor registers said first image to said second image using image based registration techniques.

7. The system of claim 6 wherein said image based registration techniques register said first image to said second image based on similar features of said first image to said second image.

8. The system of claim 1, wherein said medical device is a cranial surgical device.

9. A system for performing a medical procedure, said system comprising:
a medical device positioned within a patient anatomy, wherein said medical device includes a balloon catheter;
a first imager acquiring a first image of a patient anatomy;
a second imager acquiring a second image of a patient anatomy;
an image processor registering said first image to said second image using image based registration techniques to create a registered image of said patient anatomy; and
a workstation capable of displaying the position of said medical device within said registered image.

10. The system of claim 9 wherein said workstation controls the positioning of said medical device.

11. The system of claim 9 wherein said balloon catheter dilates within a sinus passageway of a patient.

12. The system of claim 9 wherein said image processor updates the displayed position of said medical device within said registered image in response to a change of position of said medical device.

13. A method for navigating a medical device, said method comprising:
acquiring a first image of a patient anatomy;
inserting a medical device within said patient anatomy;
acquiring a second image of a said medical device positioned within said patient anatomy;
registering said first image to said second image to create a registered image of said medical device positioned within said patient anatomy;
displaying the registered image of said medical device positioned within said patient anatomy.

14. The method of claim 13, further including acquiring a third image and registering said third image to said registered image to create a reregistered image of said medical device positioned within said patient anatomy.

15. The method of claim 13, wherein said registering step utilizes image based registration techniques.

16. The method of claim 15, wherein said image based registration techniques register said first image of a patient anatomy to said second image of said patient anatomy based on the anatomical features of said first image of said patient anatomy and said second image of said patient anatomy.

17. The method of claim 13, wherein said first image of said patient anatomy is acquired before a medical procedure.

18. The method of claim 17, wherein said first image of said patient anatomy is further comprised of a computed tomography or magnetic resonance image.

19. The method of claim 13, wherein said second image of said patient anatomy is acquired during a medical procedure.

20. The method of claim 19, wherein said second image of said patient anatomy is further comprised of a fluoroscopic image.

21. The method of claim 13, wherein said medical device is a sinuplasty device.

22. The method of claim 13, further including displaying an updated registered image of said medical device positioned within said patient anatomy in response to a change in position of said medical device positioned within said patient anatomy.
